(19) United States
(12) Patent Application Publication
(10) Pub. No.: US 2021/0150471 A1
(43) Pub. Date: May 20, 2021

(54) DYNAMICALLY ADJUSTING A SUBSCRIPTION SERVICE SCHEDULE

(71) Applicant: LENOVO (Singapore) PTE. LTD., New Tech Park (SG)

(72) Inventors: John C. Mese, Cary, NC (US); Nathan J. Peterson, Oxford, NC (US); Russell S. VanBlon, Raleigh, NC (US)

(21) Appl. No.: 16/689,772

(22) Filed: Nov. 20, 2019

(51) Int. Cl. G06Q 10/08

(52) U.S. Cl. CPC G06Q 10/0835; G06Q 10/0838

(57) ABSTRACT

Apparatuses, methods, systems, and program products are disclosed for dynamically adjusting subscription service schedule. An apparatus includes a processor and a memory that stores code executable by the processor. The code is executable by the processor to determine a subscription order schedule for a product that is ordered on a subscription basis. The code is executable by the processor to determine product usage information for the product since a most recent delivery of the product and prior to a next scheduled delivery of the product according to the subscription order schedule. The code is executable by the processor to dynamically adjust the next scheduled delivery of the subscription order schedule for the product based on the product usage information.

### FIELD

The subject matter disclosed herein relates to subscription services and more particularly relates to dynamically adjusting a subscription service schedule.

### BACKGROUND

Subscription services are a convenient way to automatically order products without shopping for them every time a product needs to be re-ordered or restocked. However, it can be difficult to know how much of a product to (re)order or a frequency with which to (re)order a product.

### BRIEF SUMMARY

Apparatuses, methods, systems, and program products are disclosed for dynamically adjusting a subscription service schedule. An apparatus, in one embodiment, includes a processor and a memory that stores code executable by the processor. In certain embodiments, the code is executable by the processor to determine a subscription order schedule for a product that is ordered on a subscription basis. In some embodiments, the code is executable by the processor to determine product usage information for the product since a most recent delivery of the product and prior to a next scheduled delivery of the product according to the subscription order schedule. In various embodiments, the code is executable by the processor to dynamically adjust the next scheduled delivery of the subscription order schedule for the product based on the product usage information.

A method for dynamically adjusting a subscription service schedule, in one embodiment, includes determining, by a processor, a subscription order schedule for a product that is ordered on a subscription basis. The method, in one embodiment, includes determining product usage information for the product since a most recent delivery of the product and prior to a next scheduled delivery of the product according to the subscription order schedule. In further embodiments, the method includes dynamically adjusting the next scheduled delivery of the subscription order schedule for the product based on the product usage information.

A computer program product for dynamically adjusting a subscription service schedule, in one embodiment, includes a computer readable storage medium having program instructions embodied therewith. In certain embodiments, the program instructions are executable by a processor to cause the processor to determine a subscription order schedule for a product that is ordered on a subscription basis. In further embodiments, the program instructions are executable by a processor to cause the processor to determine product usage information for the product since a most recent delivery of the product and prior to a next scheduled delivery of the product according to the subscription order schedule. In one embodiment, the program instructions are executable by a processor to cause the processor to dynamically adjust the next scheduled delivery of the subscription order schedule for the product based on the product usage information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamically adjusting a subscription service schedule;

FIG. 2 is a schematic block diagram illustrating one embodiment of an apparatus for dynamically adjusting a subscription service schedule;

FIG. 3 is a schematic block diagram illustrating one embodiment of another apparatus for dynamically adjusting a subscription service schedule;

FIG. 4 is a schematic flow chart diagram illustrating one embodiment of a method for dynamically adjusting subscription service schedule;

FIG. 5 is a schematic flow chart diagram illustrating one embodiment of another method for dynamically adjusting subscription service schedule;

FIG. 6 is a schematic flow chart diagram illustrating one embodiment of another method for dynamically adjusting subscription service schedule;

FIG. 7 is a schematic flow chart diagram illustrating one embodiment of another method for dynamically adjusting subscription service schedule; and

FIG. 8 is a schematic flow chart diagram illustrating one embodiment of another method for dynamically adjusting subscription service schedule.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. In certain embodiments, the code is executable by the processor to determine a subscription order schedule for a product that is ordered on a subscription basis. In some embodiments, the code is executable by the processor to determine product usage information for the product since a most recent delivery of the product and prior to a next scheduled delivery of the product according to the subscription order schedule. In various embodiments, the code is executable by the processor to dynamically adjust the next scheduled delivery of the subscription order schedule for the product based on the product usage information.

In one embodiment, the code is further executable by the processor to receive a selection of the product to be ordered on a subscription basis, receive crowd-sourced usage information related to the product based on user information for the user associated with the subscription order, and dynamically determine a baseline subscription order schedule for the product based on the crowd-sourced usage information.

In certain embodiments, the code is further executable by the processor to prompt the user for the product usage information prior to the next scheduled delivery of the product. In one embodiment, the code is further executable by the processor to periodically prompt the user a plurality of times over a period of time prior to the next scheduled delivery of the product for the product usage information. In further embodiments, the code is further executable by the processor to provide the user's reported product usage information to a crowd-sourcing service.

In one embodiment, the code is further executable by the processor to prompt the user for confirmation of the adjusted next delivery schedule for the product. The confirmation is only for adjusting the next scheduled delivery or for adjusting all future scheduled deliveries. In certain embodiments, adjusting the next scheduled delivery comprises changing one or more of a scheduled delivery date for the product and an order quantity for the product.

In one embodiment, the code is further executable by the processor to set a maximum price for the product such that a next scheduled delivery of the product is cancelled in response to a price of the product being greater than the maximum price. In further embodiments, the code is further executable by the processor to determine that the user manually adjusted the subscription order schedule for the next scheduled delivery, learn, over time, a subscription order schedule for the product based on the user's manual adjustment, and dynamically adjust one or more future scheduled deliveries of the product based on the user's manual adjustment.

In one embodiment, the code is further executable by the processor to determine, based on a user's purchase history, that the user purchased the product prior to a next scheduled delivery of the one or more products and dynamically adjust the next scheduled delivery of the product according to the subscription order schedule based on the user's purchase history.

In one embodiment, the code is further executable by the processor to determine one or more upcoming calendar events for the user prior to a next scheduled delivery of the product according to the subscription order schedule, determine whether the upcoming calendar events are related to the product, and dynamically adjust the next scheduled delivery of the product in response to the one or more upcoming calendar events being related to the product.

In one embodiment, the code is further executable by the processor to dynamically adjust a next scheduled delivery of the product according to the subscription order schedule in response to a usage of the product being impacted by a season. In certain embodiments, the code is further executable by the processor to provide suggestions for different products that the user can subscribe to that are similar to the product of the user's current subscription in response to criteria associated with the different products being more beneficial to the user than the current product's criteria.

A method for dynamically adjusting a subscription service schedule, in one embodiment, includes determining, by a processor, a subscription order schedule for a product that is ordered on a subscription basis. The method, in one embodiment, includes determining product usage information for the product since a most recent delivery of the product and prior to a next scheduled delivery of the product according to the subscription order schedule. In further embodiments, the method includes dynamically adjusting the next scheduled delivery of the subscription order schedule for the product based on the product usage information.

In one embodiment, the method includes receiving a selection of the product to be ordered on a subscription basis, receiving crowd-sourced usage information related to the product based on user information for the user associated with the subscription order, and dynamically determining a baseline subscription order schedule for the product based on the crowd-sourced usage information. In certain embodiments, the method includes setting a maximum price for the product such that a next scheduled delivery of the product is cancelled in response to a price of the product being greater than the maximum price.

In one embodiment, the method includes determining that the user manually adjusted the subscription order schedule for the next scheduled delivery, learning, over time, a subscription order schedule for the product based on the user's manual adjustment, and dynamically adjusting one or more future scheduled deliveries of the product based on the user's manual adjustment.

In one embodiment, the method includes determining, based on a user's purchase history, that the user purchased the product prior to a next scheduled delivery of the one or more products and dynamically adjusting the next scheduled delivery of the product according to the subscription order schedule based on the user's purchase history.

In one embodiment, the method includes determining one or more upcoming calendar events for the user prior to a next scheduled delivery of the product according to the subscription order schedule, determining whether the upcoming calendar events are related to the product, and dynamically adjusting the next scheduled delivery of the product in response to the one or more upcoming calendar events being related to the product.

A computer program product for dynamically adjusting a subscription service schedule, in one embodiment, includes a computer readable storage medium having program instructions embodied therewith. In certain embodiments, the program instructions are executable by a processor to cause the processor to determine a subscription order schedule for a product that is ordered on a subscription basis. In further embodiments, the program instructions are executable by a processor to cause the processor to determine product usage information for the product since a most recent delivery of the product and prior to a next scheduled delivery of the product according to the subscription order schedule. In one embodiment, the program instructions are executable by a processor to cause the processor to dynamically adjust the next scheduled delivery of the subscription order schedule for the product based on the product usage information.

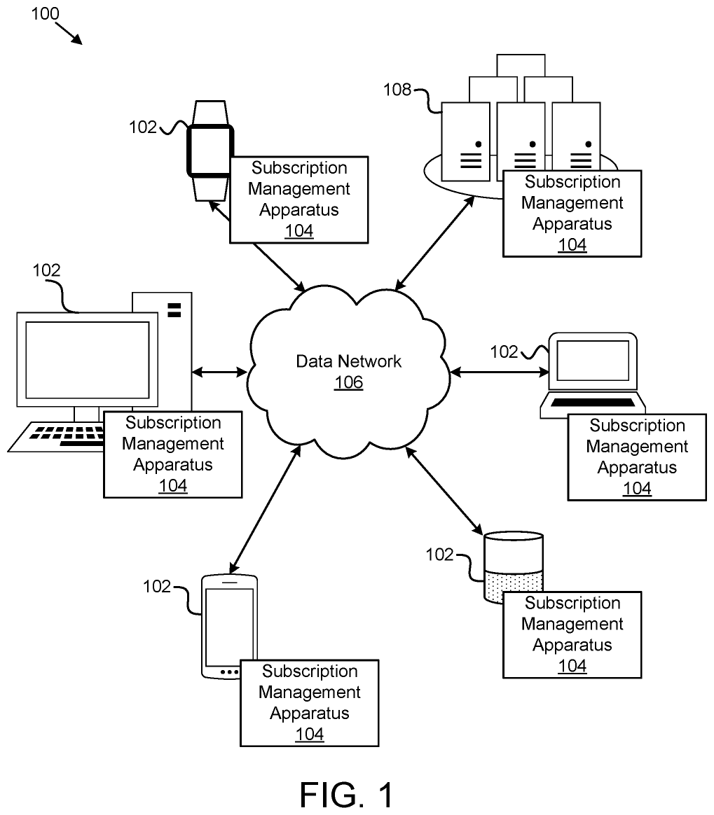

FIG. 1 is a schematic block diagram illustrating one embodiment of a system 100 for dynamically adjusting a subscription service schedule. In one embodiment, the system 100 includes one or more information handling devices 102, one or more subscription management apparatuses 104, one or more data networks 106, and one or more servers 108. In certain embodiments, even though a specific number of information handling devices 102, subscription management apparatuses 104, data networks 106, and servers 108 are depicted in FIG. 1, one of skill in the art will recognize, in light of this disclosure, that any number of information handling devices 102, subscription management apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

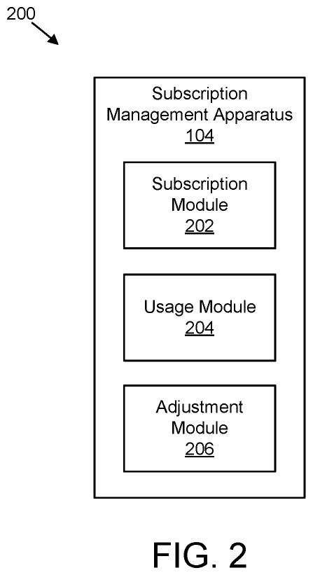

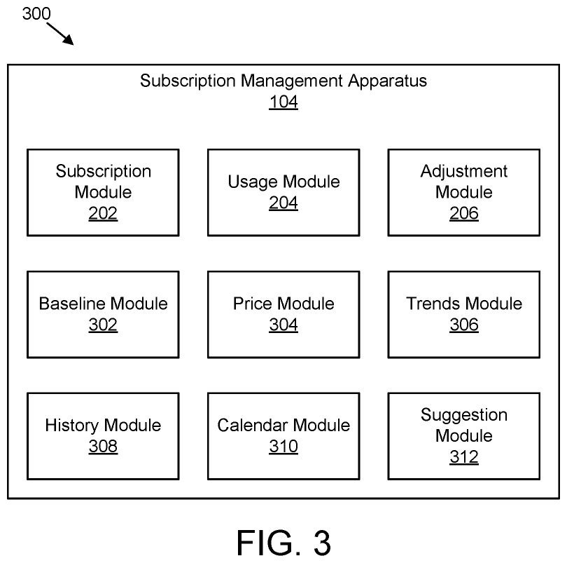

In one embodiment, the subscription management apparatus 104 is configured to determine a subscription order schedule for a product that is ordered on a subscription basis, determine product usage information for the product since a most recent delivery of the product and prior to the next scheduled delivery of the product, and dynamically adjust the next scheduled delivery of the subscription order schedule for the product based on the product usage information. The subscription management apparatus 104, including its various sub-modules, may be located on one or more information handling devices 102 in the system 100, one or more servers 108, one or more network devices, and/or the like. The subscription management apparatus 104 is described in more detail below with reference to FIGS. 2 and 3.

In various embodiments, the subscription management apparatus 104 may be embodied as a hardware appliance that can be installed or deployed on an information handling device 102, on a server 108, on a user's mobile device, on a display, or elsewhere on the data network 106. In certain embodiments, the subscription management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the subscription management apparatus 104 may include a power interface, a wired and/or wireless network interface, a graphical interface that attaches to a display, and/or a semiconductor integrated circuit device as described below, configured to perform the functions described herein with regard to the subscription management apparatus 104.

The subscription management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the subscription management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the subscription management apparatus 104.

The semiconductor integrated circuit device or other hardware appliance of the subscription management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the subscription management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The servers 108 may be third-party servers managed, hosted, maintained, or the like by e-commerce or online retailers such as Amazon®, Walmart®, or the like and are configured to manage product orders and deliveries, including product subscription orders.

FIG. 2 is a schematic block diagram illustrating one embodiment of an apparatus 200 for dynamically adjusting subscription service schedule. In one embodiment, the apparatus 200 includes an instance of a subscription management apparatus 104. The subscription management apparatus 104, in certain embodiments, includes one or more of a subscription module 202, a usage module 204, and an adjustment module 206, which are described in more detail below.

The subscription module 202, in one embodiment, is configured to determine an existing, predefined, predetermined, set, or the like subscription order schedule for a product that is ordered on a subscription basis. The product, for instance, may be a product provided, listed, advertised, or the like by an online retailer, an e-commerce business, on a social media site, or the like that provides items for sale over the Internet. The product may be a perishable product or other product that “runs out” over time as it is used such as food, pet supplies (e.g., pet food), toiletries (e.g., toothbrushes, toothpaste, shampoo, razors, deodorant, or the like), cleaning supplies (e.g., soap, paper towels, or the like), auto supplies (e.g., oil, filters, cleaning supplies, or the like), baby supplies (e.g., diapers), and/or the like.

The product may be ordered, and reordered, according to subscription terms. For example, the user may select an 8-pack of toilet paper to be automatically ordered and delivered twice a month. In such an embodiment, the online retailer may automatically order the product, charge the user's preset or default payment option (e.g., credit card) for the order, and ship the product according to a predetermined subscription order schedule that is automatically set by the retailer or by the user purchasing the product, e.g., every week, every two weeks, every month, every other month, every six months, or the like.

The subscription module 202 may access or check a user's account at an online retailer, an e-commerce site, and/or the like to determine products that the user orders on a subscription basis. The subscription module 202 module, in further embodiments, checks or searches a user's emails, text messages, or other electronic messages for information related to the user's subscription orders such as an order confirmation, a delivery notice, an invoice, and/or the like.

The usage module 204, in one embodiment, is configured to determine product usage information for the product since a most recent delivery of the product and prior to a next scheduled delivery of the product according to the subscription order schedule. In one embodiment, the usage module 204 prompts the user for feedback regarding how much of the subscription product the user has used, how much of the subscription product the user has remaining, how much of the subscription product the user estimates will be remaining at the time of the next schedule delivery of the subscription product, and/or the like.

In certain embodiments, the usage module 204 presents the prompt as a push notification, as a text message, as an instant message, as an email message, as a social media message or post, and/or the like, which the user can respond to. The usage module 204, in further embodiments, prompts the user for the product usage information prior to the next scheduled delivery of the product so that adjustments can be made to the next scheduled delivery (e.g., changing a quantity or a delivery date be sooner or later than the scheduled delivery date).

In some embodiments, the usage module 204 periodically prompts the user a plurality of times over a period of time prior to the next scheduled delivery of the product for the product usage information. For instance, the usage module 204 may prompt the user for product usage feedback once a day, every other day, once a week, every other week, and/or the like so that accurate, real-time usage data can be obtained to more finely tune the subscription order details for the subscription product.

In one embodiment, the usage module 204 may communicate with “Internet of Things” (IoT) devices within the user's home or office that are able to measure or monitor usage of the subscription product. As used herein, IoT devices may include smart devices, e.g., home appliances, that are connected to a network such as the Internet and can communicate with other IoT devices, smart phones, computing devices, etc. to provide data about the IoT device and/or to be controlled by other devices. In such an embodiment, an IoT device such as a smart scale for weighing items or a smart refrigerator may be used to measure/monitor use of the subscription product and send the usage information to the usage module 204.

For example, a bag of dog food may be weighed daily or weekly on a smart scale and the measured weight may be provided to the usage module 204 so that the usage module 204 can track the usage rate of the dog food, the amount of dog food remaining, an estimated date that the dog food will run out and need to be replenished, and/or the like. Accordingly, the adjustment module 206, described below, may dynamically adjust the subscription delivery schedule for the dog food so that a new bag of dog food is delivered at some point prior to the current bag of dog food being completely used.

The adjustment module 206, in one embodiment, is configured to dynamically adjust the next scheduled delivery of the subscription order schedule for the product based on the product usage information, e.g., the user's reported usage of the product. The adjustment may include a new delivery day, a change in the order quantity for the product, and/or the like, which may be determined based on the usage information for the product. For example, if a product is scheduled to be delivered next week, but the usage information indicates that the user has enough of the product left to last two weeks, then the adjustment module 206 may change the delivery date of the subscription order for the product from next week to the week after. Similarly, if the user is scheduled to receive a delivery of one quantity of the product, but there is an event upcoming where the product will be used a lot, the adjustment module 206 may adjust the quantity of the subscription order for the product to two, three, or four based on the amount of the product that the user has remaining.

In one embodiment, the adjustment module 206 prompts the user to confirm the determined adjustment of the subscription order schedule/terms prior to adjusting the subscription order schedule/terms. The adjustment module 206 may prompt the user for confirmation to adjust the subscription order schedule/terms using a push notification, a text message, an email message, a social media post or notification, an instant message, and/or the like. The prompt may include the adjusted delivery schedule, order quantity, and/or other terms of the adjusted subscription.

In this manner, the user's order subscription terms for a product can be dynamically adjusted on a per-order or per-delivery basis based on the usage information for the user that indicates how much of the product the user has used, how much is remaining, and/or the like. This provides a more accurate delivery schedule and/or quantity for the subscription order of the product based on the needs of the user so that the user is not required to manually monitor and determine whether their subscription order terms, e.g., delivery schedule and/or quantity, match their current or future needs. This may ensure that the user does not run out of the product prior to the next delivery or does not accumulate too much of the product over time. Furthermore, the subscription management apparatus 104 can adjust subscription terms for a product based on upcoming events, product pricing, holidays, and/or the like, as described in more detail below.

FIG. 3 is a schematic block diagram illustrating one embodiment of another apparatus 300 for dynamically adjusting subscription service schedule. In one embodiment, the apparatus 300 includes an instance of a subscription management apparatus 104. The subscription management apparatus 104, in certain embodiments, includes one or more of a subscription module 202, a usage module 204, and an adjustment module 206, which may be substantially similar to the subscription module 202, the usage module 204, and the adjustment module 206 described above with reference to FIG. 2. The subscription management apparatus 104, in further embodiments, includes a baseline module 302, a price module 304, a trends module 306, a history module 308, a calendar module 310, and a suggestion module 312, which are described in more detail below.

In one embodiment, the baseline module 302 is configured to determine baseline subscription terms for a subscription order for a product. In one embodiment, a user may select a product to order on a subscription basis, as described above, such as toiletries, food, cleaning supplies, or the like, however, when setting-up the subscription terms for the product, the user may not know how much of the product he will use, when he will need to re-order the product, and/or the like, and therefore may only guess at the quantity or frequency of the product order for the subscription.

The baseline module 302, in certain embodiments, is configured to determine accurate baseline order schedule terms for the subscription that closely resembles the user's intended use of the product and dynamically adjusts the subscription order schedule terms based on the user's usage, and other factors, over time, as described in more detail below. In this manner, the user does not order substantially more or less than the user needs or pays more for a subscription order than the user desires.

In one embodiment, the baseline module 302 is configured to receive crowd-sourced usage information related to the product based on user information for the user associated with the subscription order (e.g., the user ordering the product and setting up the subscription). The user information, for instance, may include criteria related to the user's intended use of the product. For example, the user information may include the user's family size, the number and types of pets that the user owns, information about the user's cars, the size of the user's home, and/or the like.

The baseline module 302 may prompt the user for the user information in response to the user selecting a product to be ordered on a subscription basis. The prompt may be for information related to the product. For instance, if the product is dog food, the prompt may ask how many dogs the user has, the sizes/types of the dogs, the ages of the dogs, or the like. The baseline module 302 may send the received information to a crowdsource service or engine to determine how much dog food that other user's with similar dogs use and/or how often the user's need to purchase more dog food based on their use. As used herein, crowdsourcing may refer to the process of obtaining information or input for a particular task or project from a large number of people typically via the Internet. The crowdsource service may be a separate crowdsource platform, a social network, a search of product reviews based on the user's information, and/or the like.

In one embodiment, the baseline module 302 is configured to dynamically determine a subscription order schedule for the product based on the crowdsourced usage information. For instance, the baseline module 302 may use the crowdsourced usage information to determine a baseline subscription order schedule for the product. For example, the baseline module 302 may determine from the crowdsourced usage information that two quantities of the product should be ordered every other week based on feedback from users who have similar characteristics, qualities, situations, or the like as the user ordering the product.

In this manner, the baseline module 302 can dynamically determine a baseline subscription order schedule for a product based on actual user feedback from users who have similar situations (e.g., family size, number of pets, types of pets, number of cars, types of cars, etc.) to the user ordering the subscription product, which provides the user with an accurate estimate of the amount of the product that the user will likely use to establish the subscription order schedule for the product.

In one embodiment, over time, the baseline module 302 and/or the usage module 204 is configured to provide the user's usage information to one or more crowd source services so that the usage data can be used to generate baseline subscription order delivery terms and schedules for other users that have similar characteristics of the user. For example, the user may report her weekly usage of a toothpaste product that she has ordered on a subscription basis. The baseline module 302 and/or the usage module 204 may report the user's weekly usage information to a crowdsource service where it can be aggregated or combined with other user's crowdsource information for the particular toothpaste product and used to determine a baseline subscription order delivery schedule for a different user that has similar usage characteristics.

In one embodiment, the price module 304 is configured to set a maximum price for the product subscription. For instance, the user may specify that if the product price goes above a maximum amount that the next scheduled delivery of the product is cancelled. The price module 304 may provide the user with updates regarding the price of the product so that the user can determine whether to continue with the subscription order as is, make changes to the subscription order (e.g., order more of less of the product), cancel or suspend the subscription order, and/or the like.

In one embodiment, the trends module 306 is configured to detect or determine that the user manually adjusted the terms of the subscription order (e.g., changed an order quantity for the product or changed the frequency with which the product is delivered) and learn, over time, a subscription order schedule for the product based on the user's manual adjustment of the subscription. For instance, the trends module 306 may determine that the user manually skips an order every three months or orders extra quantities of the subscription product two weeks before Christmas, or the like. Accordingly, the trends module 306 and/or the adjustment module 206 dynamically adjusts one or more future scheduled deliveries of the product based on the learned user's manual adjustments. In response to the adjusted subscription order schedule/terms for the product, the trends module 306 may notify the user of the adjusted subscription order schedule/terms (e.g., via a push notification, text message, email message, social media notification, instant message, and/or the like), which the user may confirm, reject, or change.

In one embodiment, the history module 308 is configured to determine, based on a user's purchase history, that the user purchased the product prior to a next scheduled delivery of the one or more products. The history module 308, for instance, may receive notifications, messages, signals, or the like when the user makes purchases from an online retailer where the user has a subscription order for a product. Based on the user's purchase history, the history module 308 and/or the adjustment module 206 may dynamically adjust the subscription order schedule for the product.

For example, if the history module 308 determines that the user purchased razors three weeks before a subscription order for the razors will be delivered, the history module 308 and/or the adjustment module 206 may adjust the delivery date of the next delivery for the subscription order for the razors to be a later than the currently scheduled date because the user purchased an intermediate order of the razors. Accordingly, the history module 308 and/or the adjustment module 206 may adjust the delivery date and/or quantity of the subscription order for the next scheduled delivery and/or all subsequent deliveries based on the user's purchase history.

In one embodiment, the calendar module 310 is configured to determine one or more upcoming calendar events for the user prior to a next scheduled delivery of the product according to the subscription order schedule. The calendar module 310, for instance, may determine whether there are holidays, birthdays, sporting events, and/or the like that will occur prior to the next scheduled delivery of the subscription product. If so, the calendar module 310 may determine the type of the calendar event and whether it is related to the subscription product.

For example, the calendar module 310 may determine that a sporting championship game, e.g., the Super Bowl, will occur prior to the user's next scheduled delivery of potato chips, and that potato chips are usually consumed during the sporting championship game. Accordingly, the calendar module 310 and/or the adjustment module 206 may dynamically adjust the next scheduled delivery of the product in response to the one or more upcoming calendar events being related to the product, e.g., may adjust the schedule order delivery to include a larger quantity of potato chips.

In one embodiment, the calendar module 310 and/or the adjustment module 206 dynamically adjusts the next scheduled delivery of the product according to the subscription order schedule in response to a usage of the product being impacted by a season. For instance, if the calendar module 310 determines (e.g., by referencing a calendar) that the season is changing to winter where the weather is getting colder according to an area where the user lives, then the calendar module 310 and/or the adjustment module 206 may increase a quantity of hot chocolate for the user's next subscription delivery of hot chocolate or increase a frequency with which the hot chocolate is delivered to the user. In another example, if the calendar module 310 determines that the season is changing to summer such that the weather is getting hotter in an area where the user lives, the calendar module 310 and/or the adjustment module 206 may increase a quantity of sunscreen for the user's next subscription delivery of sunscreen or increase a frequency with which the sunscreen is delivered to the user, while at the same time decreasing the quantity of hot chocolate or decreasing the frequency with which hot chocolate is delivered to the user.

The calendar module 310, in certain embodiments, may prompt the user to confirm the change to the scheduled order delivery for the calendar event, may ask the user whether the user would like to adjust the scheduled order delivery in anticipation of the scheduled calendar event (e.g., change the delivery date and/or the quantity), and/or the like.

In one embodiment, the suggestion module 312 is configured to monitor for products (e.g., from an online retailer's inventory or website) that are similar to the user's subscription products and provide suggestions for different products that the user can subscribe to based on criteria associated with the different products being more beneficial to the user than the current product's criteria. The criteria, for instance, may be a price of the product, a shipping cost for the product, discounts that are offered for the product, a quality of the product, a review rating for the product, and/or the like.

For example, the suggestion module 312 may provide a suggestion for an alternate type of soap than the current soap that the user receives on a subscription basis because the soap is less expensive than the current soap, has a higher review rating than the current soap, has a lower shipping cost than the current soap, provides more or better discounts or benefits than the current soap, and/or the like. The suggestion module 312 may automatically switch the user's subscription to the suggested product or may prompt the user to confirm switching his subscription to the suggested product. The suggestion module 312 may similarly provide suggestions for new products that the user can subscribe to based on the user's current and historical subscriptions, based on the user's purchase history, and/or the like.

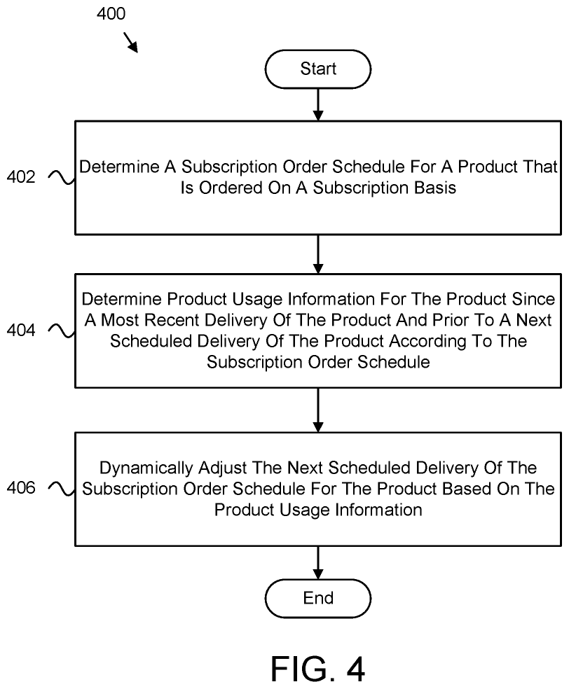

FIG. 4 is a schematic flow chart diagram illustrating one embodiment of a method 400 for dynamically adjusting subscription service schedule. In one embodiment, the method 400 begins and determines 402 a subscription order schedule for a product that is ordered on a subscription basis. In further embodiments, the method 400 determines 404 product usage information for the product since a most recent delivery of the product and prior to a next scheduled delivery of the product according to the subscription order schedule. The method 400, in some embodiments, dynamically adjusts 406 the next scheduled delivery of the subscription order schedule for the product based on the product usage information, and the method 400 ends. In one embodiment, the subscription module 202, the usage module 204, and the adjustment module 206 perform the various steps of the method 400.

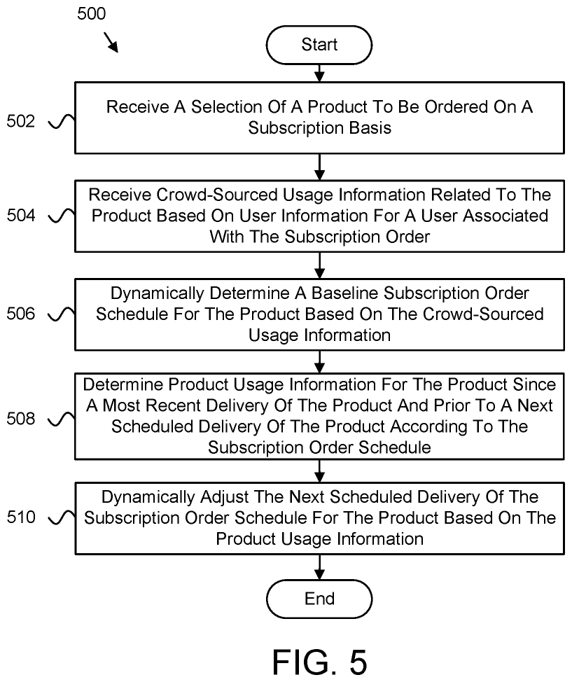

FIG. 5 is a schematic flow chart diagram illustrating one embodiment of another method 500 for dynamically adjusting subscription service schedule. In one embodiment, the method 500 begins and receives 502 a selection of a product to be ordered on a subscription basis. In further embodiments, the method 500 receives 504 crowd-sourced usage information related to the product based on user information for a user associated with the subscription order. The user information may include criteria related to the user's intended use of the product. The method 500, in some embodiments, dynamically determines 506 a baseline subscription order schedule for the product based on the crowd-sourced usage information.

In certain embodiments, the method 500 determines 508 product usage information for the product since a most recent delivery of the product and prior to a next scheduled delivery of the product according to the subscription order schedule. In further embodiments, the method 500 dynamically adjusts 510 the next scheduled delivery of the subscription order schedule for the product based on the product usage information, and the method 500 ends. In one embodiment, the subscription module 202, the usage module 204, the adjustment module 206, and the baseline module 302 perform the various steps of the method 500.

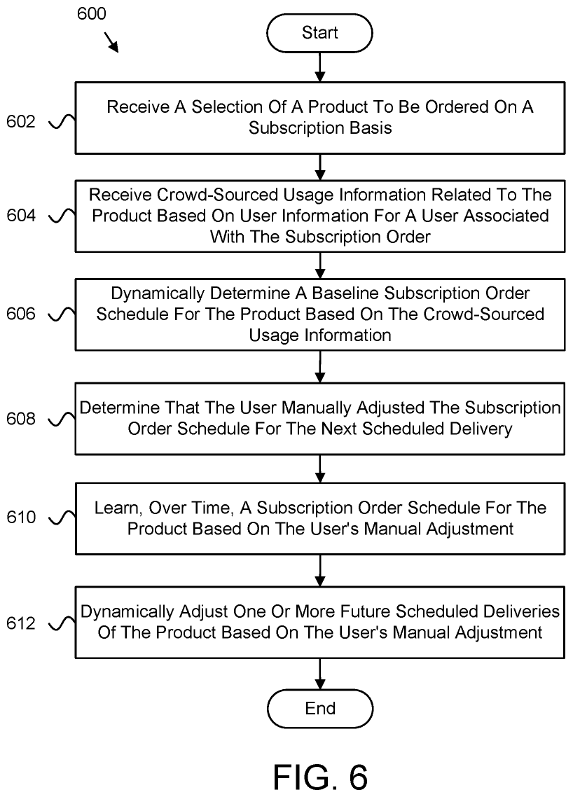

FIG. 6 is a schematic flow chart diagram illustrating one embodiment of another method 600 for dynamically adjusting subscription service schedule. In one embodiment, the method 600 begins and receives 602 a selection of a product to be ordered on a subscription basis. In further embodiments, the method 600 receives 604 crowd-sourced usage information related to the product based on user information for a user associated with the subscription order. The user information may include criteria related to the user's intended use of the product. The method 600, in some embodiments, dynamically determines 606 a baseline subscription order schedule for the product based on the crowd-sourced usage information.

In certain embodiments, the method 600 determines 608 that the user manually adjusted the subscription order schedule for the next scheduled delivery. In further embodiments, the method 600 learns 610, over time, a subscription order schedule for the product based on the user's manual adjustment. In one embodiment, the method 600 dynamically adjusts 612 one or more future scheduled deliveries of the product based on the user's manual adjustment, and the method 600 ends. In one embodiment, the subscription module 202, the usage module 204, the adjustment module 206, the baseline module 302, and the trends module 306 perform the various steps of the method 600.

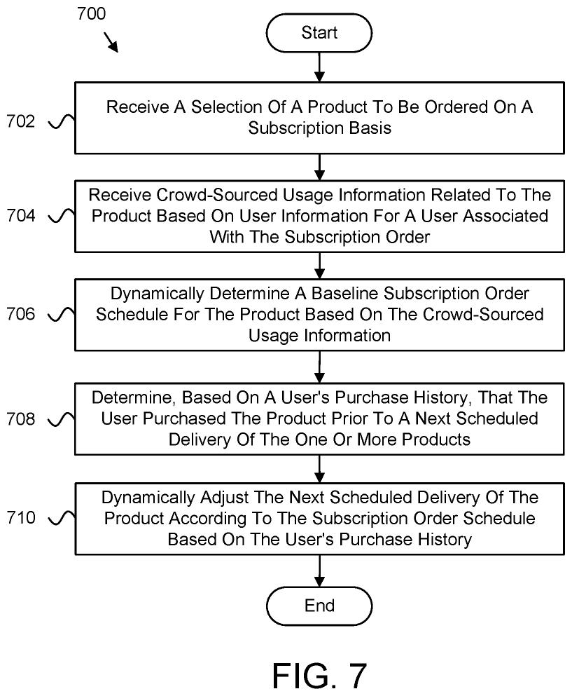

FIG. 7 is a schematic flow chart diagram illustrating one embodiment of another method 700 for dynamically adjusting subscription service schedule. In one embodiment, the method 700 begins and receives 702 a selection of a product to be ordered on a subscription basis. In further embodiments, the method 700 receives 704 crowd-sourced usage information related to the product based on user information for a user associated with the subscription order. The user information may include criteria related to the user's intended use of the product. The method 700, in some embodiments, dynamically determines 706 a baseline subscription order schedule for the product based on the crowd-sourced usage information.

In one embodiment, the method 700 determines 708, based on a user's purchase history, that the user purchased the product prior to a next scheduled delivery of the one or more products. In further embodiments, the method 700 dynamically adjusts 710 the next scheduled delivery of the product according to the subscription order schedule based on the user's purchase history, and the method 700 ends. In one embodiment, the subscription module 202, the usage module 204, the adjustment module 206, the baseline module 302, and the history module 308 perform the various steps of the method 700.

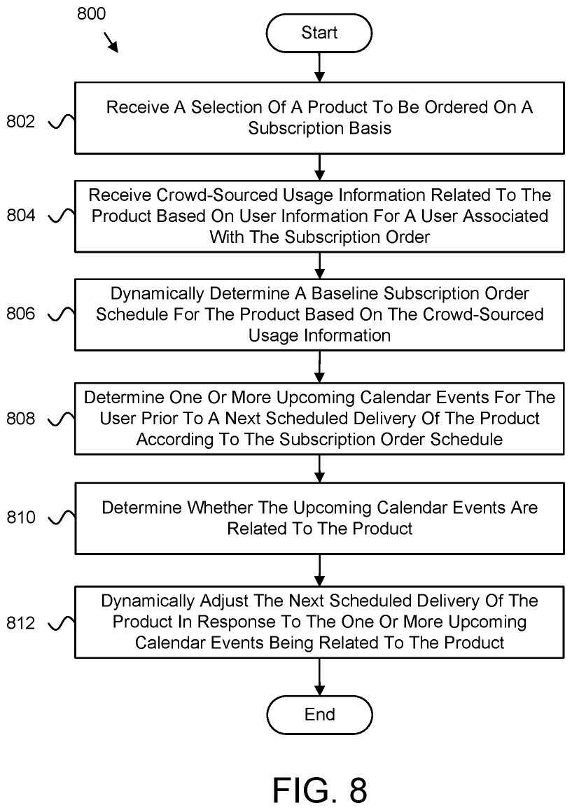

FIG. 8 is a schematic flow chart diagram illustrating one embodiment of another method 800 for dynamically adjusting subscription service schedule. In one embodiment, the method 800 begins and receives 802 a selection of a product to be ordered on a subscription basis. In further embodiments, the method 800 receives 804 crowd-sourced usage information related to the product based on user information for a user associated with the subscription order. The user information may include criteria related to the user's intended use of the product. The method 800, in some embodiments, dynamically determines 806 a baseline subscription order schedule for the product based on the crowd-sourced usage information.

In one embodiment, the method 800 determines 808 one or more upcoming calendar events for the user prior to a next scheduled delivery of the product according to the subscription order schedule. In further embodiments, the method 800 determines 810 whether the upcoming calendar events are related to the product. In certain embodiments, the method 800 dynamically adjusts 812 the next scheduled delivery of the product in response to the one or more upcoming calendar events being related to the product, and the method 800 ends. In one embodiment, the subscription module 202, the usage module 204, the adjustment module 206, the baseline module 302, and the calendar module 310 perform the various steps of the method 800.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
determine a subscription order schedule for a product that is ordered on a subscription basis;
determine product usage information for the product since a most recent delivery of the product and prior to a next scheduled delivery of the product according to the subscription order schedule; and
dynamically adjust the next scheduled delivery of the subscription order schedule for the product based on the product usage information.

2. The apparatus of claim 1, wherein the code is further executable by the processor to:
receive a selection of the product to be ordered on a subscription basis;
receive crowd-sourced usage information related to the product based on user information for the user associated with the subscription order, the user information comprising criteria related to the user's intended use of the product; and
dynamically determine a baseline subscription order schedule for the product based on the crowd-sourced usage information.

3. The apparatus of claim 1, wherein the code is further executable by the processor to prompt the user for the product usage information prior to the next scheduled delivery of the product.

4. The apparatus of claim 3, wherein the code is further executable by the processor to periodically prompt the user a plurality of times over a period of time prior to the next scheduled delivery of the product for the product usage information.

5. The apparatus of claim 1, wherein the code is further executable by the processor to provide the user's reported product usage information to a crowd-sourcing service.

6. The apparatus of claim 1, wherein the code is further executable by the processor to prompt the user for confirmation of the adjusted next delivery schedule for the product, the confirmation being only for adjusting the next scheduled delivery or for adjusting all future scheduled deliveries.

7. The apparatus of claim 1, wherein adjusting the next scheduled delivery comprises changing one or more of a scheduled delivery date for the product and an order quantity for the product.

8. The apparatus of claim 1, wherein the code is further executable by the processor to set a maximum price for the product such that a next scheduled delivery of the product is cancelled in response to a price of the product being greater than the maximum price.

9. The apparatus of claim 1, wherein the code is further executable by the processor to:
determine that the user manually adjusted the subscription order schedule for the next scheduled delivery;
learn, over time, a subscription order schedule for the product based on the user's manual adjustment; and
dynamically adjust one or more future scheduled deliveries of the product based on the user's manual adjustment.

10. The apparatus of claim 1, wherein the code is further executable by the processor to:
determine, based on a user's purchase history, that the user purchased the product prior to a next scheduled delivery of the one or more products; and
dynamically adjust the next scheduled delivery of the product according to the subscription order schedule based on the user's purchase history.

11. The apparatus of claim 1, wherein the code is further executable by the processor to:
determine one or more upcoming calendar events for the user prior to a next scheduled delivery of the product according to the subscription order schedule;
determine whether the upcoming calendar events are related to the product; and
dynamically adjust the next scheduled delivery of the product in response to the one or more upcoming calendar events being related to the product.

12. The apparatus of claim 1, wherein the code is further executable by the processor to dynamically adjust a next scheduled delivery of the product according to the subscription order schedule in response to a usage of the product being impacted by a season.

13. The apparatus of claim 1, wherein the code is further executable by the processor to provide suggestions for different products that the user can subscribe to that are similar to the product of the user's current subscription in response to criteria associated with the different products being more beneficial to the user than the current product's criteria.

14. A method, comprising:
determining, by a processor, a subscription order schedule for a product that is ordered on a subscription basis;
determining product usage information for the product since a most recent delivery of the product and prior to a next scheduled delivery of the product according to the subscription order schedule; and
dynamically adjusting the next scheduled delivery of the subscription order schedule for the product based on the product usage information.

15. The method of claim 14, further comprising:
receiving a selection of the product to be ordered on a subscription basis;
receiving crowd-sourced usage information related to the product based on user information for the user associated with the subscription order, the user information comprising criteria related to the user's intended use of the product; and
dynamically determining a baseline subscription order schedule for the product based on the crowd-sourced usage information.

16. The method of claim 14, further comprising setting a maximum price for the product such that a next scheduled delivery of the product is cancelled in response to a price of the product being greater than the maximum price.

17. The method of claim 14, further comprising:
determining that the user manually adjusted the subscription order schedule for the next scheduled delivery;
learning, over time, a subscription order schedule for the product based on the user's manual adjustment; and
dynamically adjusting one or more future scheduled deliveries of the product based on the user's manual adjustment.

18. The method of claim 14, further comprising:
determining, based on a user's purchase history, that the user purchased the product prior to a next scheduled delivery of the one or more products; and
dynamically adjusting the next scheduled delivery of the product according to the subscription order schedule based on the user's purchase history.

19. The method of claim 14, further comprising:
determining one or more upcoming calendar events for the user prior to a next scheduled delivery of the product according to the subscription order schedule;
determining whether the upcoming calendar events are related to the product; and
dynamically adjusting the next scheduled delivery of the product in response to the one or more upcoming calendar events being related to the product.

20. A computer program product, comprising a computer readable storage medium having program instructions embodied therewith, the program instructions executable by a processor to cause the processor to:
determine a subscription order schedule for a product that is ordered on a subscription basis;
determine product usage information for the product since a most recent delivery of the product and prior to a next scheduled delivery of the product according to the subscription order schedule; and
dynamically adjust the next scheduled delivery of the subscription order schedule for the product based on the product usage information.
